(19) United States
(12) Patent Application Publication
(10) Pub. No.: US 2026/0205419 A1
(43) Pub. Date: Jul. 16, 2026

(54) MANAGING A DATA STREAMING SESSION

(71) Applicant: QUALCOMM Incorporated, San Diego, CA (US)

(72) Inventors: Mengjun LENG, Shanghai (CN); Zhou GAO, Shanghai (CN); Fei LIANG, Shanghai (CN)

(21) Appl. No.: 19/128,928

(22) PCT Filed: Jan. 25, 2023
(86) PCT No.: PCT/CN2023/073465

§ 371 Date: May 9, 2025

(51) Int. Cl. H04L 47/27

(52) U.S. Cl. CPC H04L 47/27

(57) ABSTRACT

Embodiments of systems and methods for managing a data streaming session may include identifying one or more parameters of a second communication link in response to determining that a user equipment (UE) that is receiving data for a data streaming session has changed from a first communication link to the second communication link, selecting an initial congestion window size that is larger than a default congestion window size based on the one or more parameters of the second communication link, and applying the selected initial congestion window size to the data streaming session.

### BACKGROUND

Long Term Evolution (LTE), Fifth Generation (5G) New Radio (NR), and other communication technologies enable improved communication and data services. One such service is data streaming, which may be used to support a variety of applications, such as multimedia applications, online gaming, voice and video conferencing, and other suitable applications. User equipment (UE) may receive streamed data over a wireless communication link for use by such an application.

Some UEs are mobile, and may change network connections due to mobility while receiving streamed data. Current data streaming management processes may detect the change in network connections and may unnecessarily restrict a data rate, which may starve the application of streamed data.

### SUMMARY

Various aspects include systems and methods performed by a user equipment (UE) for managing a data streaming session. While receiving data in a streaming data session, the UE may change a network connection from a first communication link to a second communication link. The first communication link may be with a first communication network, and the second communication link may be with a second communication network. In response to determining that the UE has changed from the first communication link to the second communication link, the UE may identify one or more parameters of the second communication link. The UE may select an initial congestion window size that is larger than a default congestion window size based on the one or more parameters of the second communication link. The UE may apply the selected initial congestion window size to the data streaming session.

In some aspects, identifying the one or more parameters of the second communication link may include identifying by a monitor service executing in a framework of the UE the one or more parameters of the second communication link. In some aspects, identifying the one or more parameters of the second communication link may include identifying a location of an access point that provides the second communication link. In some aspects, identifying the one or more parameters of the second communication link may include identifying one or more network-configured parameters of the second communication link.

Some aspects may include identifying an application requirement of an application executing on the UE that receives data from the data streaming session, wherein selecting the initial congestion window size that is larger than the default congestion window size is based on the application requirement. In some aspects, identifying the one or more parameters of the second communication link may include identifying one or more historical parameters of the second communication link. In such aspects, selecting the initial congestion window size that is larger than the default congestion window size may be based on the one or more historical parameters of the second communication link.

Some aspects may include identifying monitoring the one or more parameters of the second communication link, and updating the initial congestion window size and storing the updated initial congestion window size in a memory of the UE. Some aspects may include identifying one or more of the parameters of the second communication link in response to determining that data that the UE is transmitting for the data streaming session is approaching saturation, selecting a second congestion window size that is less than or equal to a congestion window size returned by a congestion algorithm based on the one or more parameters of the second communication link, and applying the selected second congestion window size to the data streaming session.

In some aspects, identifying the one or more parameters of the second communication link may include identifying by the monitor service executing in the framework of the UE the one or more parameters of the second communication link. In some aspects, identifying the one or more parameters of the second communication link may include identifying one or more historical parameters of the second communication link, and selecting the second congestion window size that that is less than or equal to the value of the curve of congestion algorithm is based on the one or more historical parameters of the second communication link. Some aspects may include monitoring the one or more parameters of the second communication link, and updating the second congestion window size and storing the updated second congestion window size in a memory of the UE.

Further aspects include a UE having a processor configured to perform one or more operations of any of the methods summarized above. Further aspects include processing devices for use in a UE configured with processor-executable instructions to perform operations of any of the methods summarized above. Further aspects include a non-transitory processor-readable storage medium having stored thereon processor-executable instructions configured to cause a processor of a UE to perform operations of any of the methods summarized above. Further aspects include a UE having means for performing functions of any of the methods summarized above.

Further aspects include a system on chip for use in a UE and that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4A is a block diagram illustrating an example system architecture suitable for implementing any of the various embodiments.

FIG. 4B is an illustration of a TCP congestion control process suitable for implementing any of the various embodiments.

FIG. 5A is a process flow diagram illustrating a method that may be performed by a processor of a UE for managing a data streaming session in accordance with various embodiments.

FIGS. 5B-5E are process flow diagrams illustrating operations that may be performed as part of the method for managing a data streaming session in accordance with various embodiments.

FIG. 6 is a component block diagram of a UE suitable for use with various embodiments.

FIG. 7 is a component block diagram of a network device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include a UE in a data streaming session using a first communication link identifying parameters of a second communication link in response to the data streaming session changing from the first communication link to the second communication link. The UE may use identified parameters of the second communication link to select an initial congestion window size that is larger than a default congestion window size and then apply the selected initial congestion window size to the data streaming session. Various embodiments enable the UE to increase the efficiency of streaming data packet communication when the UE is mobile, such as when the UE changes wireless communication links frequently. This may improve the operation and performance of streaming data applications and services when the UE changes data connections.

The term “user equipment” (UE) is used herein to refer to any one or all of wireless communication devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, wireless router devices, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Enhanced Data rates for Global System for Mobile communications (GSM) Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Mobile UEs may change network connections while receiving streamed data in a given data streaming session. Current data streaming management processes may detect a change in network connections and in response unnecessarily restrict the data rate of the streaming session. Restricting the data rate may starve the application of streamed data.

Restrictions in data rate that occurs when network connections changes can be caused by congestion avoidance processes, such as the network congestion avoidance procedures used in the Transfer Control Protocol (TCP), that involve the UE and the network computing device sending and receiving signaling to control an amount of data transmitted to the UE. Congestion avoidance processes may include an additive increase/multiplicative decrease (AIMD) scheme, a slow start process, and a congestion window (CWND).

The congestion window is a factor used in determining an amount of data (e.g., a number of bytes) that streaming data source device may transmit per unit time, in order to exercise control over an amount of data conveyed by a communication link between the transmitter and a receiving device (e.g., a UE). The AIMD algorithm is a closed-loop control algorithm that combines growth of the congestion window with an exponential reduction when network congestion is detected. The slow start mechanism is an aspect of TCP congestion avoidance processes that may be used by TCP, Stream Control Transmission Protocol (SCTP), and other suitable protocols in conjunction with other algorithms to avoid sending more data than the network is capable of forwarding, thereby attempting to control network congestion. While examples herein are described using TCP as an example, this is not intended as a limitation, and the systems and methods described herein may be used in other data streaming management processes, other congestion avoidance processes, and/or the like.

Conventionally, TCP congestion avoidance procedures adjust the congestion window size according to a detected network status, such as based on packet loss statistics. A UE that changes communication links (e.g., from a first communication link to a second communication link) during a data streaming session may select a congestion window that is inappropriate for the second communication link. For example, the UE may reset the congestion window to a small initial value, or retain a congestion window value that is unnecessarily small for the actual conditions of the second communication link. As a consequence, conventional TCP congestion avoidance procedures may not stream data to an application at a rate sufficient to meet a minimum performance level. When this happens, conventional TCP congestion avoidance procedures may starve the application of necessary streaming data.

Various embodiments enable the UE to perform operations to manage a data streaming session by obtaining a variety of information about a communication link that the UE is switching to and determining (selecting, generating) an initial congestion window size that is appropriate to conditions of that communication link. In some embodiments, the UE may identify one or more parameters of a second communication link in response to determining that the UE that is receiving data for a data streaming session has changed or is changing from a first communication link to the second communication link. Based on the one or more parameters of the second communication link, the UE may select an initial congestion window size that is larger than a default congestion window size. The UE may then apply the selected initial congestion window size to the data streaming session.

In some embodiments, a UE may be configured with a monitor service executing in a framework of the UE. The monitor service may be configured to identify one or more parameters of the second communication link. In some embodiments, the monitor service may receive the one or more parameters of the second communication link from a process or module executing in the UE, for example, from a Transfer Control Protocol/Internet Protocol (TCP/IP) stack executing in the UE.

The UE may identify (obtain, receive) one or more parameters of the second communication link. In some embodiments, the UE may identify a location of an access point that provides the second communication link. The access point location may be a physical or geographic location, or the location may be a network location.

In some embodiments, the parameter(s) may include an access point identifier or access point name. In some embodiments, the parameter(s) may include a network type, or a radio access technology (RAT) type, such as 3G, 4G, 5G, Wi-Fi, and the like. It some embodiments, the UE may identify one or more network-configured parameters of the second communication link. Network-configured parameter(s) may include a quality of service (QoS) configured by a network element of the communication network for the second communication link. Network-configured parameter(s) also may include a physical cell ID (PCI). Network-configured parameter(s) also may include an operation mode of the access point, such as Standalone (SA) or Non-Standalone (NSA) mode.

In some embodiments, the one or more parameters of the second communication link may include a date and/or time that the UE switches to or establishes the second communication link. In some embodiments, the parameter(s) may include information about an application executing in the UE that uses the streaming data. Such information may include an identifier of the application, and/or one or more data requirements of the application, such as a minimum data rate, a minimum throughput, a minimum performance requirement, or a QoS requirement of the application. In some embodiments, the parameter(s) of the second communication link may include one or more historical parameters of the second communication link, such as any or all of the above parameters that the UE may have identified or obtained at a previous time when switching to the second communication link.

Based on the one or more parameters of the second communication link, the UE may select an initial congestion window size that is larger than the default congestion window size. The UE may apply the selected initial congestion window size to the data streaming session. In some embodiments, the UE may monitor the one or more parameters of the second communication link during the data streaming session after the UE has switched to the second communication link. In some embodiments, the UE may update or adjust the initial congestion window size, and store the updated initial congestion window size in the memory of the UE. In some embodiments, the UE may obtain the stored initial congestion window size from the memory of the UE at the future time when the UE switches to the second communication link. In some embodiments, the UE may use the stored initial congestion window size as a starting point at a future time and may adjust the initial congestion window size obtained from memory based on one or more identified parameters of the second communication link.

In the context of a congestion control algorithm, the curve typically refers to a relationship between the rate at which data is transmitted and the amount of congestion experienced in the network. The rate of data transmission may increase as the network capacity allows, but may decrease as congestion increases in order to avoid overwhelming the network and causing further delays. This relationship may be represented graphically as a curve, with the x-axis representing the rate of data transmission and the y-axis representing the level of congestion in the network. The curve may start at a low transmission rate and gradually increase as the network becomes less congested, but may flatten out or decrease as congestion increases. In some embodiments, the congestion control algorithm may be configured to determine a balance (which may be an optimized balance) between maximizing the rate of data transmission and minimizing the impact of congestion on the network.

In some embodiments, the UE may identify the one or more parameters of the second communication link in response to determining that data that the UE is transmitting for the data streaming session is approaching saturation. In some embodiments, the one or more parameters of the second communication link may include parameters for data received by the UE and parameters for data transmitted by the UE (e.g., whole traffic parameters). In some embodiments, if the communication link (or the network) reaches saturation, the network may be unable to convey data at a faster rate, even if the sender is willing to send data at a higher rate. The UE may select a second congestion window size that is less than or equal to a congestion window size returned by a congestion algorithm based on the one or more parameters of the second communication link. The UE may apply the selected second congestion window size to the data streaming session.

In some embodiments, the UE may identify the one or more of the parameters of the second communication link by the monitor service executing in the framework of the UE. In some embodiments, the UE may identify one or more historical parameters of the second communication link, and may select the second congestion window size that that is less than or equal to the value of the curve of congestion algorithm is based on the one or more historical parameters of the second communication link. In some embodiments, the UE may monitor the one or more parameters of the second communication link, and may update the second congestion window size and store the updated second congestion window size in a memory of the UE.

Various embodiments improve wireless communications of data for data streaming and applications that use streamed data by enabling UEs to improve data transmission rates when changing network connections. Various embodiments improve the operation of UEs and streaming data applications by enabling the UE to determine an appropriate initial congestion window size for a second communication link to which the UE may switch.

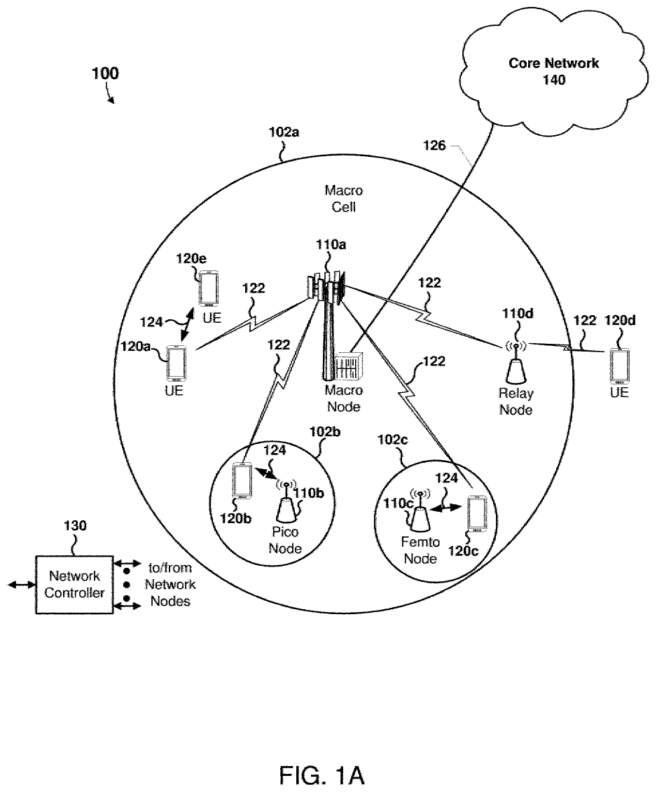

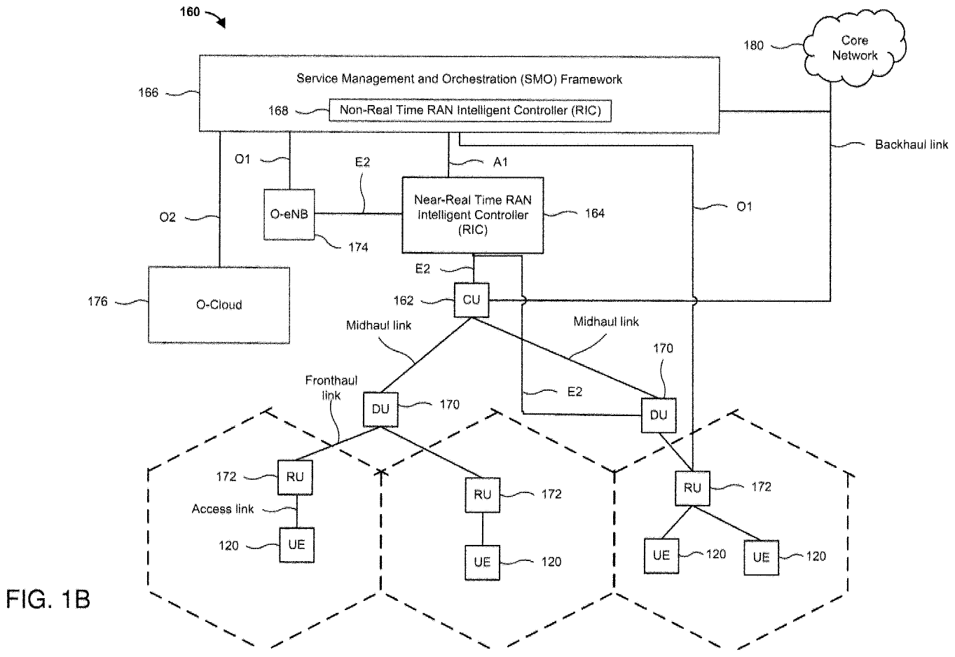

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 also may include a number of network devices 110a, 110b, 110c, and 110d and other network entities, such as base stations and network nodes. A network device is an entity that communicates with UEs, and in various embodiments may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. In various communication network implementations or architectures, a network device may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network entity) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC. Each network device may provide communication coverage for a particular geographic area. In 3GPP, the term “cell” can refer to a coverage area of a network device, a network device subsystem serving this coverage area, or a combination thereof, depending on the context in which the term is used. The core network 140 may be any type core network, such as an LTE core network (e.g., an evolved packet core (EPC) network), 5G core network, etc.

A network device 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network device for a macro cell may be referred to as a macro node or macro base station. A network device for a pico cell may be referred to as a pico node or a pico base station. A network device for a femto cell may be referred to as a femto node, a femto base station, a home node or home network device. In the example illustrated in FIG. 1A, a network device 110a may be a macro node for a macro cell 102a, a network device 110b may be a pico node for a pico cell 102b, and a network device 110c may be a femto node for a femto cell 102c. A network device 110a-110d may support one or multiple (for example, three) cells.

The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device, such as a network node or mobile network device. In some examples, the network devices 110a-110d may be interconnected to one another as well as to one or more other network devices (e.g., base stations or network nodes (not illustrated)) in the communications system 100 through various types of backhaul interfaces, such as a direct physical connection, a virtual network, or a combination thereof using any suitable transport network The network device 110a-110d may communicate with the core network 140 over a wired or wireless communication link 126. The UE 120a-120e may communicate with the network node 110a-110d over a wireless communication link 122. The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay network device 110d). A relay station is an entity that can receive a transmission of data from an upstream station (for example, a network device or a UE) and transmit the data to a downstream station (for example, a UE or a network device). A relay station also may be a UE that can relay transmissions for other UEs. In the example illustrated in FIG. 1A, a relay station 110d may communicate with macro the network device 110a and the UE 120d in order to facilitate communication between the network device 110a and the UE 120d. A relay station also may be referred to as a relay network device, a relay base station, a relay, etc.

The communications system 100 may be a heterogeneous network that includes network devices of different types, for example, macro network devices, pico network devices, femto network devices, relay network devices, etc. These different types of network devices may have different transmit power levels, different coverage areas, and different impacts on interference in communications system 100. For example, macro nodes may have a high transmit power level (for example, 5 to 40 Watts) whereas pico network devices, femto network devices, and relay network devices may have lower transmit power levels (for example, 0.1 to 2 Watts).

A network controller 130 may couple to a set of network devices and may provide coordination and control for these network devices. The network controller 130 may communicate with the network devices via a backhaul. The network devices also may communicate with one another, for example, directly or indirectly via a wireless or wireline backhaul.

The UEs 120a, 120b, 120c may be dispersed throughout communications system 100, and each UE may be stationary or mobile. A UE also may be referred to as an access terminal, a terminal, a mobile station, a subscriber unit, a station, wireless device, etc.

A macro network device 110a may communicate with the communication network 140 over a wired or wireless communication link 126. The UEs 120a, 120b, 120c may communicate with a network device 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz).

Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHZ, respectively.

While descriptions of some implementations may use terminology and examples associated with LTE technologies, some implementations may be applicable to other wireless communications systems, such as a new radio (NR) or 5G network.

NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported. Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, remote devices, sensors, meters, monitors, location tags, etc., that may communicate with a network device, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IOT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an EPC network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a network node 110a-110d as an intermediary to communicate with one another). For example, the UEs 120a-120e may communicate using peer-to-peer (P2P) communications, device-to-device (D2D) communications, a mesh network, or similar networks, a vehicle-to-everything (V2X) protocol (which may include a vehicle-to-vehicle (V2V) protocol, a vehicle-to-infrastructure (V2I) protocol, or a similar protocol), or combinations thereof. In this case, the UE 120a-120e may perform scheduling operations, resource selection operations, as well as other operations described elsewhere herein as being performed by the network node 110a-110d.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUS, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various embodiments.

With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links.

The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units.

Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an Al interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as Al policies).

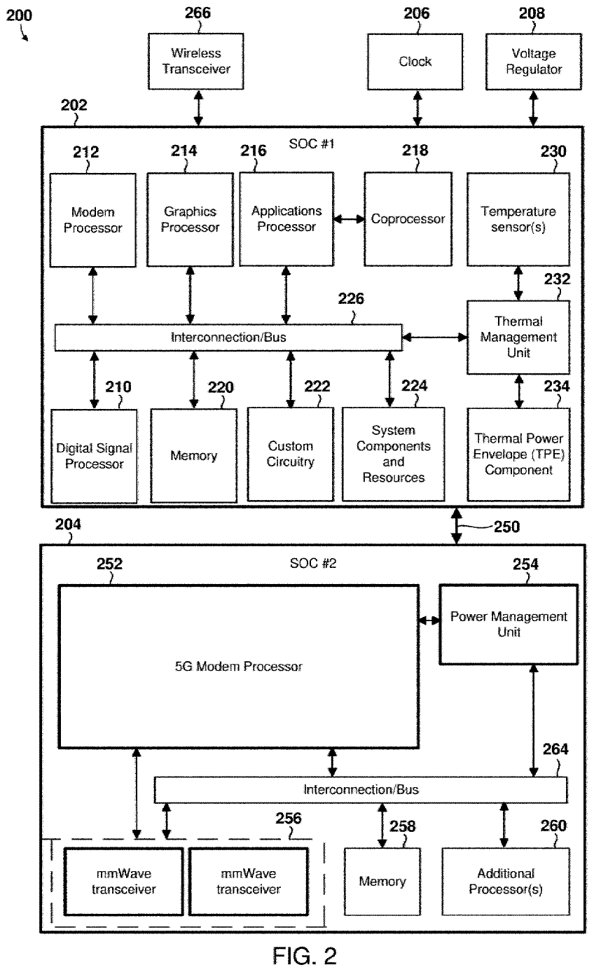

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a UE (e.g., 120a-120e) or a network device (e.g., 110a-110d). In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit.

For example, the second SOC 204 may operate as a specialized 5G processing unit responsible for managing high volume, high speed (such as 5 Gbps, etc.), and/or very high frequency short wavelength (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mm Wave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mm Wave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

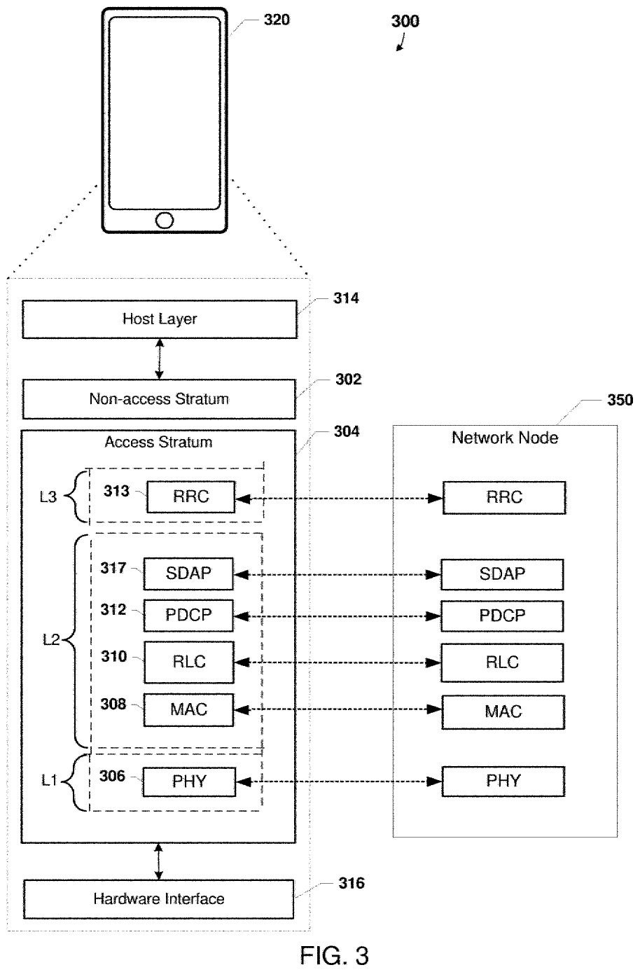

FIG. 3 is a component block diagram illustrating a software architecture 300 including a radio protocol stack for the user and control planes in wireless communications suitable for implementing any of the various embodiments. With reference to FIGS. 1A-3, the UE 320 may implement the software architecture 300 to facilitate communication between a UE 320 (e.g., the UE 120a-120e, 200) and the network device 350 (e.g., the network device 110a-110d) of a communication system (e.g., 100). In various embodiments, layers in software architecture 300 may form logical connections with corresponding layers in software of the network device 350. The software architecture 300 may be distributed among one or more processors (e.g., the processors 212, 214, 216, 218, 252, 260). While illustrated with respect to one radio protocol stack, in a UE having a multi-subscriber identity module (SIM), the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the UE (such as SIM(s) 204) and its core network 140. The AS 304 may include functions and protocols that support communication between a SIM(s) (such as SIM(s) 204) and entities of supported access networks (such as a network device, network node, RU, base station, etc.). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the UE 320 and the network node 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the network node 350.

In the control plane, Layer 3 (L3) of the AS 304 may include a radio resource control (RRC) sublayer 3. While not shown, the software architecture 300 may include additional Layer 3 sublayers, as well as various upper layers above Layer 3.

In some implementations, the RRC sublayer 313 may provide functions including broadcasting system information, paging, and establishing and releasing an RRC signaling connection between the UE 320 and the network node 350.

In various embodiments, the SDAP sublayer 317 may provide mapping between Quality of Service (QoS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some implementations, application-specific functions provided by the at least one host layer 314 may provide an interface between the software architecture and the general purpose processor (e.g., 202).

In other implementations, the software architecture 300 may include one or more higher logical layers (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

In various network implementations or architectures, in the network device 350 the different logical layers 308-317 may be implemented in an aggregated or monolithic base station architecture, or alternatively, in a disaggregated network device architecture, and various logical layers may implemented in one or more of a CU, a DU, an RU, a Near-RT RAN Intelligent Controller (RIC), or a Non-Real Time (Non-RT) RIC. Further, the network device 350 may be implemented as an aggregated base station, as a disaggregated base station, an integrated access and backhaul (IAB) node, a relay node, a sidelink node, etc.

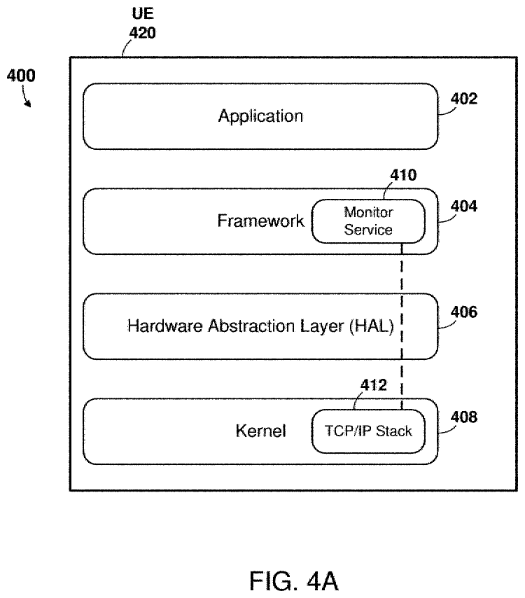

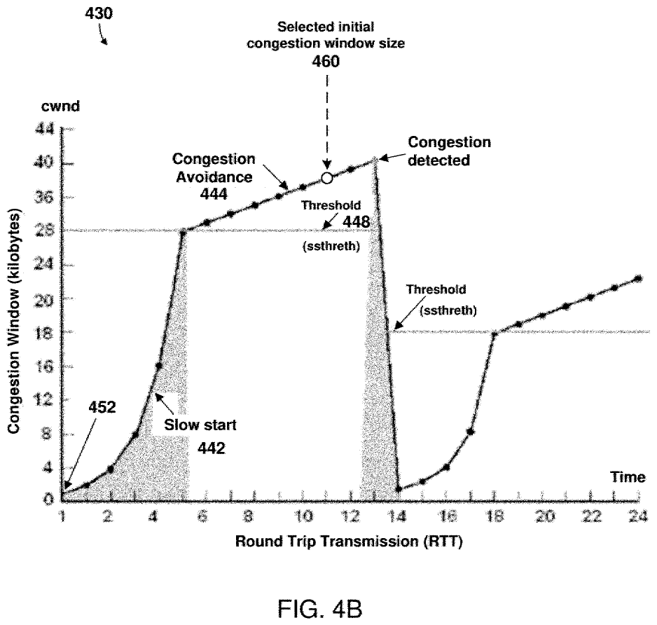

FIG. 4A is a block diagram illustrating an example system architecture 400 suitable for implementing any of the various embodiments. The system architecture 400 is illustrated as a high-level system architecture of the Android operating system, but this is not intended as a limitation, and the system architecture 400 may include similar or analogous elements that may be implemented with other operating systems.

With reference to FIGS. 1A-4A, a UE 420 (e.g., 120a-120e, 200, 320) may include the system architecture 400. The system architecture 400 may include an application layer 402, a framework 404, a hardware abstraction layer (HAL) 406, and a kernel 408 (e.g., a Linux kernel). In some embodiments, a monitor service 410 may execute in or be instantiated in the framework 404. The monitor service 410 may communicate with modules or processes such as TCP/IP stack 412. The monitor service 410 may identify, obtain, and/or receive one or more parameters of a second communication link established by the UE 420, or to which the UE 420 has switched.

FIG. 4B is an illustration of a TCP congestion control process 430 suitable for implementing any of the various embodiments. With reference to FIGS. 1A-4A, the congestion control process 430 may be implemented in a UE (e.g., 120a-120e, 200, 320, 420). Conventionally, a congestion control process 430 may begin using a default congestion window size 452 at the start of a slow start phase 442, and may increase the congestion window size until the congestion window meets a threshold 448. When the congestion window meets the threshold 448, the congestion control process 430 may shift to a congestion avoidance phase 444, during which the congestion control process 430 may increase the congestion window size more gradually.

In various embodiments, the UE may use a congestion window size that is larger than the default congestion window size 452, based on one or more parameters of a communication link to which the UE has switched (a second communication link). In this manner, the UE may not perform, such as skip or avoid the slow start phase 442 as well as at least a portion of the congestion avoidance phase 444. Instead, the UE may apply the selected initial congestion window size 460 to the data streaming session.

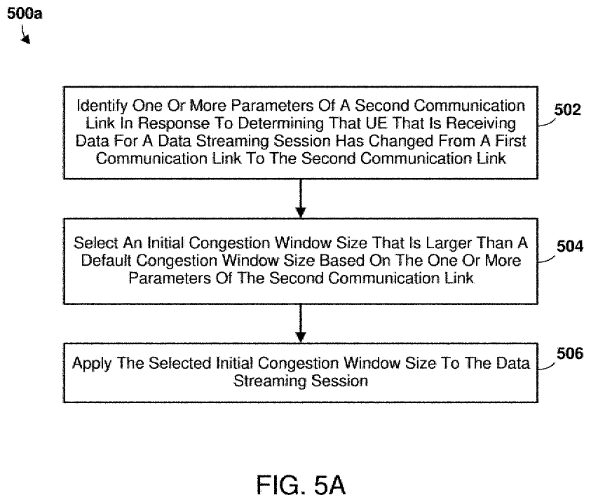

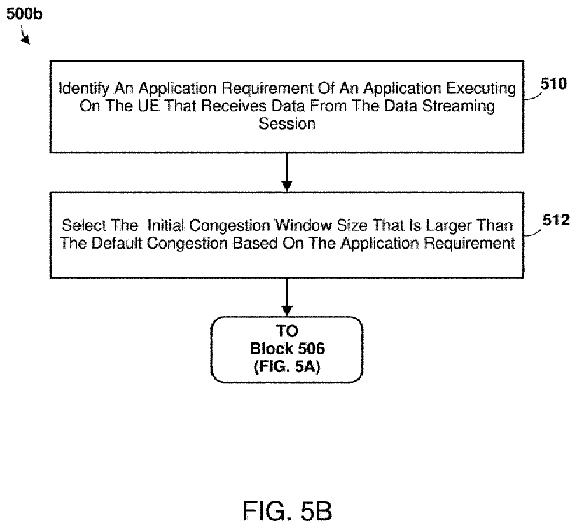

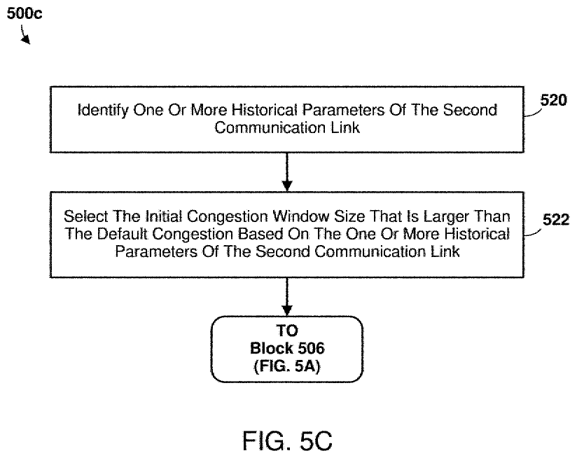

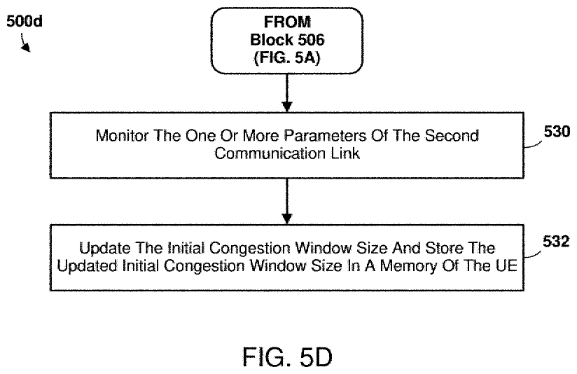

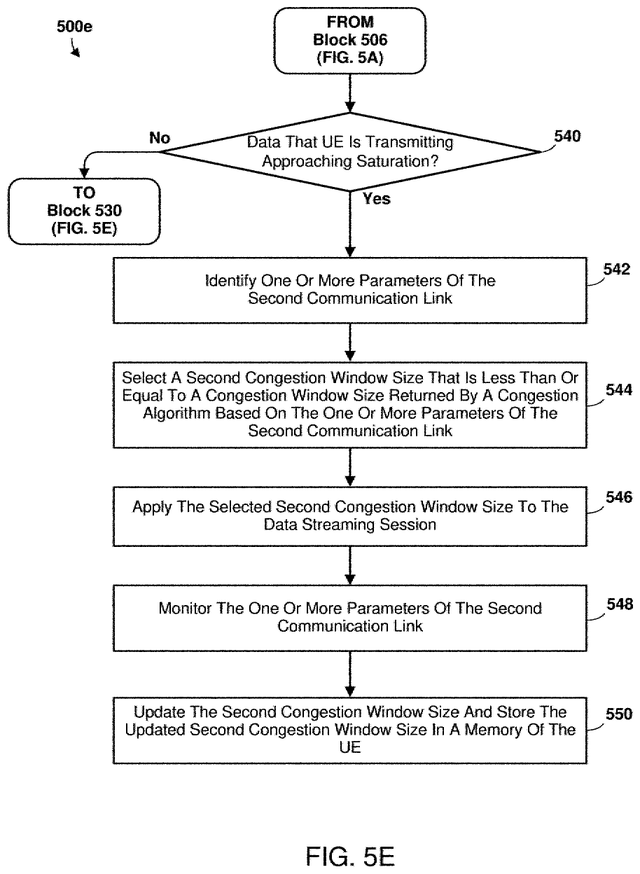

FIG. 5A is a process flow diagram illustrating a method 500a that may be performed by a processor of a UE for managing a data streaming session in accordance with various embodiments. With reference to FIGS. 1A-5A, the operations of the method 500a may be performed by a processor (such as the processor 210, 212, 214, 216, 218, 252, 260) of a UE (such as the UE 120a-120e, 200, 320, 420), and is referred to generally herein as a “processor.”

In block 502, the processor may identify one or more parameters of a second communication link in response to determining that a UE that is receiving data for a data streaming session has changed from a first communication link to the second communication link. In some embodiments, the first communication link may be with a first communication network, and the second communication link may be with a second communication network. For example, the UE may switch from a first communication link with a cellular network to a second communication link with a Wi-Fi network. As another example, the UE may switch from a first communication link with a first cellular network (e.g., 3G, 4G) to a second communication link with a second cellular network (e.g., 5G, 6G). In some embodiments, the UE may identify the one or more parameters of the second communication link by or using a monitor service executing in a framework of the UE.

In some embodiments, the UE may identify a location of an access point that provides a second communication link. In some embodiments, the UE may identify one or more network-configured parameters of the second communication link.

In block 504, the processor may select an initial congestion window size that is larger than a default congestion window size based on the one or more parameters of the second communication link.

In block 506, the processor may apply the selected initial congestion window size to the data streaming session.

FIG. 5B is a process flow diagram illustrating operations 500b that may be performed as part of the method 500a for managing a data streaming session in accordance with various embodiments. With reference to FIGS. 1A-5B, the operations 500b may be performed by a processor (such as the processor 210, 212, 214, 216, 218, 252, 260) of a UE (such as the UE 120a-120e, 200, 320, 420), and is referred to generally herein as a “processor.”

In block 510, the processor may identify an application requirement of an application executing on the UE that receives data from the data streaming session. In some embodiments, the processor may identify one or more of a minimum data rate, a minimum throughput, a minimum performance requirement, a QoS requirement of the application, or another suitable requirement of the application.

In block 512, the processor may select the initial congestion window size based on the application requirement. In some embodiments, the processor may use the application requirement together with other information, such as the location of the access point that provides the second communication link, one or more network-configured parameters of the second communication link, and/or the like, to select the initial congestion window size.

The processor may apply the selected initial congestion window size to the data streaming session in block 506 as described.

FIG. 5C is a process flow diagram illustrating operations 500c that may be performed as part of the method 500a for managing packet transmissions to a UE in accordance with various embodiments. With reference to FIGS. 1A-5C, the operations 500c may be performed by a processor (such as the processor 210, 212, 214, 216, 218, 252, 260) of a UE (such as the UE 120a-120e, 200, 320, 420), and is referred to generally herein as a “processor.”

In block 520, the processor may identify one or more historical parameters of the second communication link. In some embodiments, such historical parameters may include parameters that the UE identified or obtained at a previous time when switching to the second communication link. Such previously-obtain parameters may include the location of the access point, one or more network-configured parameters of the communication link, dates and/or times when the UE previously switched to the second communication link, information about what application(s) were executing in the UE when the UE previously switched to the second communication link, application requirement(s) of such application(s), and/or other suitable historical parameters that may enable the UE to determine data usage and/or carriage capacity of the second communication link.

In block 522, the processor may select the initial congestion window size based on the one or more historical parameters of the second communication link. In some embodiments, the processor may use the together with other information, such as an application requirement of an application currently executing in the UE, the location of the access point that provides the second communication link, one or more network-configured parameters of the second communication link, and/or the like, to select the initial congestion window size.

The processor may apply the selected initial congestion window size to the data streaming session in block 506 as described.

FIG. 5D is a process flow diagram illustrating operations 500d that may be performed as part of the method 500a for managing packet transmissions to a UE in accordance with various embodiments. With reference to FIGS. 1A-5D, the operations 500d may be performed by a processor (such as the processor 210, 212, 214, 216, 218, 252, 260) of a UE (such as the UE 120a-120e, 200, 320, 420), and is referred to generally herein as a “processor.”

After applying the selected initial congestion window size to the data streaming session in block 506 as described, the processor may monitor the one or more parameters of the second communication link in block 530. For example, the processor may monitor one or more of any of the parameters described above. The processor also may monitor the performance of the congestion control process or congestion control algorithm (such as any TCP congestion control or congestion avoidance processes). The processor also may monitor the performance of one or more applications executing in the UE that use data conveyed by the second communication link.

In block 532, the processor may update the initial congestion window size and store the updated initial congestion window size in a memory of the UE. In some embodiments, at a future time when the UE switches to the second communication link, the UE may obtain the stored initial congestion window size from the memory of the UE. In some embodiments, at the future time, the UE may use the stored initial congestion window size as a starting point, and may adjust the initial congestion window size obtained from memory based on one or more identified parameters of the second communication link.

FIG. 5E is a process flow diagram illustrating operations 500e that may be performed as part of the method 500a for managing packet transmissions to a UE in accordance with various embodiments. With reference to FIGS. 1A-5E, the operations 500e may be performed by a processor (such as the processor 210, 212, 214, 216, 218, 252, 260) of a UE (such as the UE 120a-120e, 200, 320, 420), and is referred to generally herein as a “processor.”

After applying the selected initial congestion window size to the data streaming session in block 506 as described, the processor may determine whether data that the UE is transmitting for the data streaming session is approaching saturation in determination block 540. In some embodiments, if the second communication link reaches saturation, the network may be unable to convey data at a faster rate.

In response to determining that the data that the UE is transmitting for the data streaming session is not approaching saturation (i.e., determination block 540=“No”), the processor may monitor the one or more parameters of the second communication link in block 530 (FIG. 5E) as described.

In response to determining that the data that the UE is transmitting for the data streaming session is approaching saturation (i.e., determination block 540=“Yes”), the processor may identify one or more of the parameters of the second communication link in block 542. In some embodiments, the processor may identify the one or more parameters of the second communication link using the monitor service executing in the framework of the UE. In some embodiments, the processor may identify one or more historical parameters of the second communication link.

In block 544, the processor may select a second congestion window size that is less than or equal to a congestion window size returned by a congestion algorithm based on the one or more parameters of the second communication link. In some embodiments, the processor may select the second congestion window size based on one or more historical parameters of the second communication link.

In block 546, the processor may apply the selected second congestion window size to the data streaming session.

In block 548, the processor may monitor the one or more parameters of the second communication link.

In block 550, the processor may update the second congestion window size and storing the updated second congestion window size in a memory of the UE.

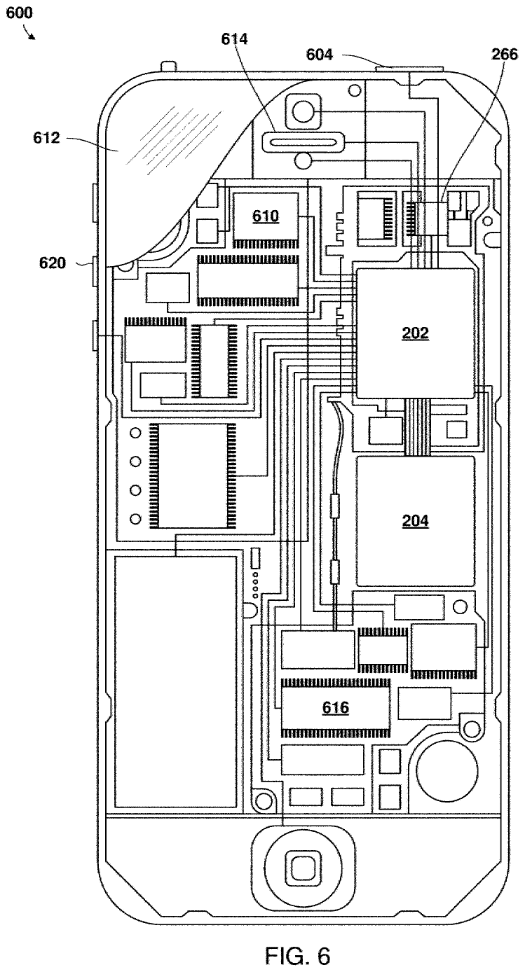

FIG. 6 is a component block diagram of a UE 600 suitable for use with various embodiments. With reference to FIGS. 1A-6, various embodiments may be implemented on a variety of UEs 600 (for example, the UEs 120a-120e, 200, 320, 420), an example of which is illustrated in FIG. 6 in the form of a smartphone. The UE 600 may include a first SOC 202 (for example, a SOC-CPU) coupled to a second SOC 204 (for example, a 5G capable SOC). The first and second SOCs 202, 204 may be coupled to internal memory 616, a display 612, and to a speaker 614. Additionally, the UE 600 may include an antenna 604 for sending and receiving electromagnetic radiation that may be connected to a wireless transceiver 266 coupled to one or more processors in the first and/or second SOCs 202, 204. The UE 600 may include menu selection buttons or rocker switches 620 for receiving user inputs. The UE 600 may include a sound encoding/decoding (CODEC) circuit 610, which digitizes sound received from a microphone into data packets suitable for wireless transmission and decodes received sound data packets to generate analog signals that are provided to the speaker to generate sound. One or more of the processors in the first and second SOCs 202, 204, wireless transceiver 266 and CODEC 610 may include a digital signal processor (DSP) circuit (not shown separately).

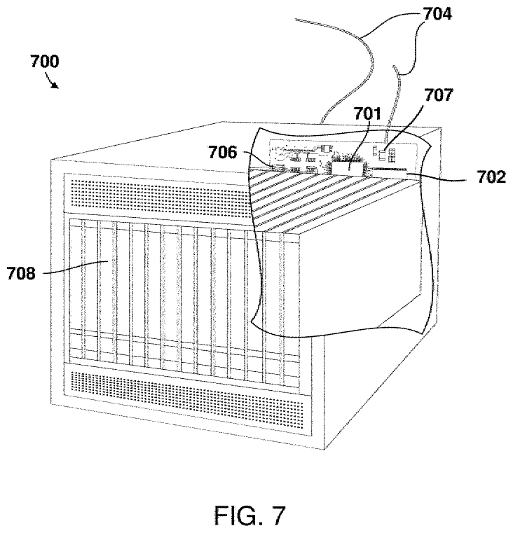

FIG. 7 is a component block diagram of a network device suitable for use with various embodiments. Such network devices (e.g., network device 110a-110d, 350, 406, 410, 414) may include at least the components illustrated in FIG. 7. With reference to FIGS. 1A-7, the network device 700 may typically include a processor 701 coupled to volatile memory 702 and a large capacity nonvolatile memory, such as a disk drive 708. The network device 700 also may include a peripheral memory access device 706 such as a floppy disc drive, compact disc (CD) or digital video disc (DVD) drive coupled to the processor 701. The network device 700 also may include network access ports 704 (or interfaces) coupled to the processor 701 for establishing data connections with a network, such as the Internet or a local area network coupled to other system computers and servers. The network device 700 may include one or more antennas 707 for sending and receiving electromagnetic radiation that may be connected to a wireless communication link. The network device 700 may include additional access ports, such as USB, Firewire, Thunderbolt, and the like for coupling to peripherals, external memory, or other devices.

The processors of the UE 600 and the network device 700 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 616, 708 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations disclosed herein may be substituted for or combined with one or more operations of the methods and operations disclosed herein.

Implementation examples are described in the following paragraphs. While some of the following implementation examples are described in terms of example methods, further example implementations may include: the example methods discussed in the following paragraphs implemented by a UE including a processor configured with processor-executable instructions to perform operations of the methods of the following implementation examples; the example methods discussed in the following paragraphs implemented by a UE including means for performing functions of the methods of the following implementation examples; and the example methods discussed in the following paragraphs may be implemented as a non-transitory processor-readable storage medium having stored thereon processor-executable instructions configured to cause a processor of a UE to perform the operations of the methods of the following implementation examples.

Example 1. A method of managing a data streaming session, including identifying one or more parameters of a second communication link in response to determining that a user equipment (UE) that is receiving data for a data streaming session has changed from a first communication link to the second communication link, selecting an initial congestion window size that is larger than a default congestion window size based on the one or more parameters of the second communication link, and applying the selected initial congestion window size to the data streaming session.

Example 2. The method of example 1, in which identifying the one or more parameters of the second communication link includes identifying by a monitor service executing in a framework of the UE the one or more parameters of the second communication link.

Example 3. The method of either of examples 1 or 2, in which identifying the one or more parameters of the second communication link includes identifying a location of an access point that provides the second communication link.

Example 4. The method of any of examples 1-3, in which identifying the one or more parameters of the second communication link includes identifying one or more network-configured parameters of the second communication link.

Example 5. The method of any of examples 1-4, further including identifying an application requirement of an application executing on the UE that receives data from the data streaming session, in which selecting the initial congestion window size that is larger than the default congestion window size is based on the application requirement.

Example 6. The method of any of examples 1-5, in which identifying the one or more parameters of the second communication link includes identifying one or more historical parameters of the second communication link, and selecting the initial congestion window size that is larger than the default congestion window size is based on the one or more historical parameters of the second communication link.

Example 7. The method of any of examples 1-6, further including monitoring the one or more parameters of the second communication link, and updating the initial congestion window size and storing the updated initial congestion window size in a memory of the UE.

Example 8. The method of any of examples 1-7, further including identifying one or more of the parameters of the second communication link in response to determining that data that the UE is transmitting for the data streaming session is approaching saturation, selecting a second congestion window size that is less than or equal to a congestion window size returned by a congestion algorithm based on the one or more parameters of the second communication link, and applying the selected second congestion window size to the data streaming session.

Example 9. The method of example 8 in which identifying the one or more parameters of the second communication link includes identifying by the monitor service executing in the framework of the UE the one or more parameters of the second communication link.

Example 10. The method of either of examples 8 or 9, in which identifying the one or more parameters of the second communication link includes identifying one or more historical parameters of the second communication link, and selecting the second congestion window size that that is less than or equal to the value of the curve of congestion algorithm is based on the one or more historical parameters of the second communication link.

Example 11. The method of any of examples 8-10, further including monitoring the one or more parameters of the second communication link, and updating the second congestion window size and storing the updated second congestion window size in a memory of the UE.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running in a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon.

Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of managing a data streaming session, comprising:
identifying one or more parameters of a second communication link in response to determining that a user equipment (UE) that is receiving data for a data streaming session has changed from a first communication link to the second communication link;
selecting an initial congestion window size that is larger than a default congestion window size based on the one or more parameters of the second communication link; and
applying the selected initial congestion window size to the data streaming session.

2. The method of claim 1, wherein identifying the one or more parameters of the second communication link comprises identifying by a monitor service executing in a framework of the UE the one or more parameters of the second communication link.

3. The method of claim 1, wherein identifying the one or more parameters of the second communication link comprises identifying a location of an access point that provides the second communication link.

4. The method of claim 1, wherein identifying the one or more parameters of the second communication link comprises identifying one or more network-configured parameters of the second communication link.

5. The method of claim 1, further comprising identifying an application requirement of an application executing on the UE that receives data from the data streaming session,
wherein selecting the initial congestion window size that is larger than the default congestion window size is based on the application requirement.

6. The method of claim 1, wherein:
identifying the one or more parameters of the second communication link comprises identifying one or more historical parameters of the second communication link, and
selecting the initial congestion window size that is larger than the default congestion window size is based on the one or more historical parameters of the second communication link.

7. (canceled)

8. The method of claim 1, further comprising:
identifying one or more of the parameters of the second communication link in response to determining that data that the UE is transmitting for the data streaming session is approaching saturation;
selecting a second congestion window size that is less than or equal to a congestion window size returned by a congestion algorithm based on the one or more parameters of the second communication link; and
applying the selected second congestion window size to the data streaming session.

9. (canceled)

10. The method of claim 8, wherein:
identifying the one or more parameters of the second communication link comprises identifying one or more historical parameters of the second communication link, and
selecting the second congestion window size that that is less than or equal to the value of the curve of congestion algorithm is based on the one or more historical parameters of the second communication link.

11. The method of claim 8, further comprising:
monitoring the one or more parameters of the second communication link; and updating the second congestion window size and storing the updated second congestion window size in a memory of the UE.

12. A user equipment (UE), comprising:
a processor configured with processor-executable instructions to:
identify one or more parameters of a second communication link in response to determining that the UE that is receiving data for a data streaming session has changed from a first communication link to the second communication link;
select an initial congestion window size that is larger than a default congestion window size based on the one or more parameters of the second communication link; and
apply the selected initial congestion window size to the data streaming session.

13. The UE of claim 12, wherein the processor is further configured with processor-executable instructions to identify by a monitor service executing in a framework of the UE the one or more parameters of the second communication link.

14. The UE of claim 12, wherein the processor is further configured with processor-executable instructions to identify a location of an access point that provides the second communication link.

15. The UE of claim 12, wherein the processor is further configured with processor-executable instructions to identify one or more network-configured parameters of the second communication link.

16. The UE of claim 12, wherein the processor is further configured with processor-executable instructions to:
identify an application requirement of an application executing on the UE that receives data from the data streaming session; and
select the initial congestion window size that is larger than the default congestion window size based on the application requirement.

17. The UE of claim 12, wherein the processor is further configured with processor-executable instructions to:
identify one or more historical parameters of the second communication link, and select the initial congestion window size that is larger than the default congestion window size based on the one or more historical parameters of the second communication link.

18. (canceled)

19. The UE of claim 12, wherein the processor is further configured with processor-executable instructions to:
identify one or more of the parameters of the second communication link in response to determining that data that the UE is transmitting for the data streaming session is approaching saturation;
select a second congestion window size that is less than or equal to a congestion window size returned by a congestion algorithm based on the one or more parameters of the second communication link; and
apply the selected second congestion window size to the data streaming session.

20. The UE of claim 19 wherein the processor is further configured with processor-executable instructions to identify by the monitor service executing in the framework of the UE the one or more parameters of the second communication link.

21. The UE of claim 19, wherein the processor is further configured with processor-executable instructions to:
identify one or more historical parameters of the second communication link, and select the second congestion window size that that is less than or equal to the value of the curve of congestion algorithm based on the one or more historical parameters of the second communication link.

22. The UE of claim 19, wherein the processor is further configured with processor-executable instructions to:
monitor the one or more parameters of the second communication link; and
update the second congestion window size and storing the updated second congestion window size in a memory of the UE.

23. A user equipment (UE), comprising:
means for identifying one or more parameters of a second communication link in response to determining that the UE that is receiving data for a data streaming session has changed from a first communication link to the second communication link;
means for selecting an initial congestion window size that is larger than a default congestion window size based on the one or more parameters of the second communication link; and
means for applying the selected initial congestion window size to the data streaming session.

24-30. (canceled)
